(19) United States
(12) Patent Application Publication
(10) Pub. No.: US 2025/0002780 A1
(43) Pub. Date: Jan. 2, 2025

(54) COLORIMETRIC RADIATION DETECTOR

(71) Applicant: UNM RAINFOREST INNOVATIONS, Albuquerque, NM (US)

(72) Inventors: Fernando GARZON, Santa Fe, NM (US); Timothy J. BOYLE, Albuquerque, NM (US); Kannan RAMAIYAN, Albuquerque, NM (US); Kyle TROCHE, Albuquerque, NM (US)

(73) Assignees: UNM RAINFOREST INNOVATIONS, Albuquerque, NM (US); National Technology & Engineering Solutions of Sandia, LLC, Albuquerque, NM (US)

(21) Appl. No.: 18/706,272

(22) PCT Filed: Nov. 2, 2022
(86) PCT No.: PCT/US2022/048698

§ 371 Date: Apr. 30, 2024

Related U.S. Application Data
(60) Provisional application No. 63/338,739, filed on May 5, 2022.
(60) Provisional application No. 63/275,196, filed on Nov. 3, 2021.

(51) Int. Cl. C09K 11/07; C09B 11/08; C09B 11/24; C09B 67/42; C09K 11/02; G01J 1/50; G01T 1/16

(52) U.S. Cl. CPC C09K 11/07; C09B 11/08; C09B 11/24; C09B 67/0092; C09K 11/02; G01J 1/50; G01T 1/1606; C09K 2211/1007; C09K 2211/1018

(57) ABSTRACT

A colorimetric radiation detector and a method for detecting radiation is disclosed. The colorimetric radiation detector also includes a metal oxyhalide that reaches an excited state on exposure to x-ray or ultraviolet radiation. The detector also includes a dye or where the metal oxyhalide is a bismuth oxyhalide, such as a bismuth oxychloride. The dye may include a redox reactive dye. The redox reactive dye may include Rhodamine B. The dye undergoes a permanent color change by reacting with the metal oxyhalide when the metal oxyhalide is exposed to x-ray or ultraviolet radiation. The dye may include a fluorescent dye, such as a fluorescein dye, such as 6-carboxy fluorescein or 5-carboxy fluorescein. The solvent may include a Lewis base solvent. The Lewis base solvent may include water or an alcohol. A method for evaluating a photoprotective topical lotion is also disclosed.

### CROSS REFERENCE TO RELATED APPLICATIONS

This application is a U.S. National Phase application of PCT/US2022/048698 filed Nov. 2, 2022, which claims the benefit of U.S. Provisional Patent Application No. 63/275,196, filed on Nov. 3, 2021, and U.S. Provisional Patent Application No. 63/338,739, filed on May 5, 2022, the disclosures of which are incorporated by reference herein in their entireties.

### TECHNICAL FIELD

The present teachings relate generally to radiation detection and, more particularly, to a direct-reading colorimetric radiation detector.

### BACKGROUND

Current dosimeters (radiographic films, scintillation detectors, ion chambers) suffer many drawbacks: difficulty interpreting signals, high cost, complexity of operation, and, they are often single-point detectors. Colorimetric radiation detectors produce a change in color or absorption when exposed to radiation due to the presence of one or more photochromic dyes in the detector. A leading sensing mechanism is the radiation-induced fluorescence quenching of the organic dye 4,4′-di(1H-phenanthro [9,10-d]imidazol-2-yl)-biphenyl (DPI-BP). See J.-M. Han et al., J. Am. Chem. Soc. 136, 5090 (2014). This compound is highly fluorescent in chlorinated solvents (e.g., CHCl₃, CH₂Cl₂) until exposed to >0.01 Gy gamma-radiation. The radiation stimulus generates free radicals (·H, ·Cl) from decomposition of the chlorinated solvent. Some of the in situ generated radicals form HCl molecules which then react with the DPI-BP to generate a salt at the imidazole linkage (HNC₅H₃N·HCl) of the DPI-BP complex. The salts favor π-π stacking which leads to molecular aggregation and quenching of the fluorescent activity. While this is an acceptable process, the need for a hazardous Cl-based solvent to quench the fluorescence limits its utility in different surfaces or architectures. Further, these relatively inexpensive materials suffer from poor sensitivity and only function in the liquid state.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A colorimetric radiation detector is disclosed. The colorimetric radiation detector also includes a metal oxyhalide that reaches an excited state on exposure to x-ray or ultraviolet radiation. The detector also includes a dye. Implementations of the colorimetric radiation detector may include where the metal oxyhalide is a bismuth oxyhalide. The metal oxyhalide may include a bismuth oxychloride. The dye may include a redox reactive dye. The redox reactive dye may include Rhodamine B. The dye undergoes a permanent color change by reacting with the metal oxyhalide when the metal oxyhalide is exposed to x-ray or ultraviolet radiation. The dye may include a fluorescent dye. The fluorescent dye may include a fluorescein dye, such as 6-carboxy fluorescein or 5-carboxy fluorescein. The colorimetric radiation detector may include an absorbent medium onto which the metal oxyhalide and the dye are absorbed. The absorbent medium may include paper. A metal halide and the dye are dissolved in the solvent, and the metal oxyhalide is formed by introducing the metal halide into the solvent. The solvent may include a Lewis base solvent. The Lewis base solvent may include water or an alcohol. A concentration of the metal oxyhalide is from about 5 mM to about 1M. The colorimetric radiation detector may include a radiation filter. The radiation filter absorbs radiation within a portion of a range of ultraviolet radiation.

A method for detecting radiation is disclosed. The method for detecting radiation includes providing a colorimetric radiation detector, where the colorimetric radiation detector may include a metal oxyhalide that reaches an excited state on exposure to x-ray or ultraviolet radiation, and a dye that undergoes a permanent color change by reacting with the metal oxyhalide when the metal oxyhalide is exposed to x-ray or ultraviolet radiation. The method for detecting radiation also includes exposing the colorimetric radiation detector to radiation. The method for detecting radiation also includes detecting a change in color of the colorimetric radiation detector. Implementations of the method for detecting radiation may include where the metal oxyhalide includes a bismuth oxychloride. The dye may include Rhodamine B.

A method for evaluating a photoprotective topical lotion is disclosed, including providing a colorimetric radiation detector including a metal oxyhalide that reaches an excited state on exposure to x-ray or ultraviolet radiation, applying a skin-like testing substrate over at least a portion of the colorimetric radiation detector. The method also includes applying a photoprotective topical lotion onto at least a portion of the skin-like testing substrate. The method also includes exposing the colorimetric radiation detector to radiation. The method also includes detecting a change in color of the colorimetric radiation detector. Implementations of the method for evaluating a photoprotective topical lotion may include where the colorimetric radiation detector includes a dye that undergoes a permanent color change by reacting with the metal oxyhalide when the metal oxyhalide is exposed to x-ray or ultraviolet radiation. The dye may include a fluorescent dye. The radiation is exposed to the colorimetric radiation detector in a non-uniform distribution. The radiation exposed to the colorimetric radiation detector is in the ultraviolet range. The method for evaluating a photoprotective topical lotion may include blocking at least a portion of the colorimetric radiation detector from being exposed to radiation. The metal oxyhalide may include a bismuth oxyhalide. The metal oxyhalide may include a bismuth oxychloride.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1D are a series of photographs depicting soaked and dried filter paper squares in 1 mM, 5 mM, 10 mM, and 100 mM BiCl₃ dissolved in ethanol and exposed to 254 nm UV, 302 nm UV, 365 nm UV, and sunlight, respectively, for one hour, in accordance with the present disclosure.

FIGS. 2A-2C are a series of photographs depicting soaked and dried filter paper squares in 1 mM 6-carboxy fluorescein (6-CF) and 100 mM BiCl₃ in ethanol exposed to 365 nm UV, 302 nm UV, and 254 nm UV, respectively, at various time lengths, in accordance with the present disclosure.

FIGS. 3A-3F are a series of photographs depicting various percentages of 0.1 mM Rhodamine B (RB) and 100 mM BiCl₃ in ethanol as prepared, and exposed to 302 nm UV light for 1 hour, 2 hours, 3 hours, 4 hours, and 5 hours, respectively, in accordance with the present disclosure.

FIGS. 4A-4G are plots depicting UV-Vis absorption data for various percentages of 0.1 mM Rhodamine B (RB) and 100 mM BiCl₃ in ethanol exposed to 302 nm UV light, for compositions including 100% RB, 83% RB, 66% RB, 50% RB, 34% RB, 17% RB, and 100% BiCl₃, respectively, in accordance with the present disclosure.

FIGS. 5A-5D are photographs depicting various percentages of 0.1 mM Rhodamine B (RB) and 100 mM BiCl₃ in ethanol exposed to 302 nm UV light for 5 hours, continuously, with a 2-day rest after the initial 5 hour exposure to 302 nm UV light, immediately after the 5 hour exposure, 45 minutes after the 5 hour exposure, and after overnight settling, respectively, in accordance with the present disclosure.

FIG. 6A is a schematic and picture of an experimental setup of a 302 nm UV light SPF 30 sunscreen test, in accordance with the present disclosure.

FIG. 6B is a photograph depicting results of a 50% 1 mM 6-CF and 100 mM BiCl3 UV sensor SPF 30 sunscreen test with 302 nm UV light, with 2 hour and 4 hour exposure with no sunscreen, 1 hour, 2 hour, and 26 hour exposure with sunscreen, respectively, in accordance with the present disclosure.

FIG. 6C is a schematic of a sunlight and SPF 30 sunscreen test, in accordance with the present disclosure.

FIG. 6D is a set of photographs depicting a 50% 1 mM 6-CF and 100 mM BiCl3 UV sensor SPF 30 sunscreen test with sunlight, in accordance with the present disclosure.

FIG. 6E depicts a Kodak No. 3 Calibrated Step Tablet scanned with an Epson Expression 1680 Professional Scanner, denoting optical density values are listed below each step, in accordance with the present disclosure.

FIG. 6F depicts an 8-bit gray scale conversion of 302 nm solid-state sensor image, in accordance with the present disclosure.

FIGS. 6G and 6H are plots of optical density values of 50% 1 mM 6-CF and 100 mM BiCl3 solid-state sensors when exposed to 365 nm light, 302 nm light, 254 nm light, and sunlight as a function of time and dosage, respectively, in accordance with the present disclosure.

FIGS. 6I and 6J depict filter paper squares soaked in 500 mM BiCl3 and ethanol exposed to 302 nm UV light for various durations, and a Plot of optical density values with respect to 302 nm exposure time, respectively, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present invention is directed to a radiation-induced fluorescence quenching method and colorimetric radiation detector with enhanced sensitivity/quenching behavior to enable remote detection of radiation. The present invention uses radiation-induced fluorescence quenching of organic chemical fluorophores and chemical-amplification, rather than a photomultiplier tube, for detection. The quenched luminosity can be remotely detected using commercial laser probes due to the high-contrast change upon exposure. When used for radiation detection, the technology can remotely monitor low doses of radiation that can be easily detected in a passive, continuous (infinite) mode while encompassing a large physical area.

In general, the colorimetric radiation detector of the present invention comprises a metal halide (MX) that readily hydrolyzes to its metal-oxyhalide in aqueous solvents which upon exposure to radiation, change color either by decomposition or by oxygen vacancy creation; and a dye whose fluorescence is quenched by a product (M or X) of the metal halide decomposition. The metal halide can comprise a high-atomic-number metal, such as a high-atomic-number transition metal or a lanthanide series heavy metal, having adequate stopping power to absorb the incident radiation. Preferably, the metal halide comprises a high-atomic-number post-transition metal, such as bismuth, lead, or tin. The metal halide can comprise a halogen that can easily form a free radical, such as fluorine, chlorine, bromine, or iodine. The metal halide can further comprise an electron-donating co-ligand, such as an alkoxide. The dye can be any number of quenchable dyes, such as fluorescein, coumarin, or rhodamine. The metal halide and dye can be dissolved in a common solvent. The solvent preferably comprises a Lewis basic solvent, such as water or an alcohol, such as methanol, ethanol, or propanol. Alternatively, the solvent can be an aromatic solvent, such as phenol, toluene or xylene. The radiation can typically be high-energy ionizing radiation from an ultraviolet (UV), X-ray, gamma-ray, or particle source.

As an example of the invention, the organic chlorinated solvent of the prior system of J.-M. Han et al. can be replaced with an inorganic metal halide, greatly simplifying the system, enhancing its sensitivity, and allowing for more complex geometries to be used as sensors. The exemplary method comprises the efficient radiolysis production of radicals ·Cl from a metal chloride MClₙ, and the capture of ·Cl by dye molecules and subsequent quenching of fluorescent activity. Commercially available metal chlorides (MClₙ) and a fluorescein dye molecule (referred to as FDM) can be used. The metal chloride preferably has weak M-Cl bonds that enable the rapid production of MOCl and ·Cl radicals upon exposure to radiation. Homoleptic MClₙ does not necessarily offer the best process for halide formation, therefore an electron-donating co-ligand (i.e., (OR)_{z}MCl_{n-z}) that promote radicalization can be used. Using quantum-based computational modeling as a screening tool, fine tuning of this system can provide the most sensitive radical MClₙ generators and receptive dye molecules possible for a specific radiation source/level.

The formation of ·Cl can be generated under similar conditions, but a solid or liquid sensor can be used. This allows for production of more accessible and less obvious sensors (i.e., paint). The use of MClₙ precursors as a source of ·Cl is well established with several being stable; however, these typically involve complex ligands bound to the metal. As an example, commercially available MClₙ mixed with FDMs can be as a radiation-induced fluorescence quenching system for remote detection of gamma-radiation. High-atomic-number MClₙ precursors can be used as a source of ·Cl in the presence of FDMs. A high number of coordinated Cl can be radicalized, ensuring an economical use of the inorganic precursor. A radiation-induced fluorescence quenching system for remote detection of low levels of gamma or other forms of radiation can thereby be created through computationally refined MClₙ/FDM systems, providing enhanced sensitivity coupled with an extremely versatile material form enabling significant improvements in the remote detection of gamma-radiation.

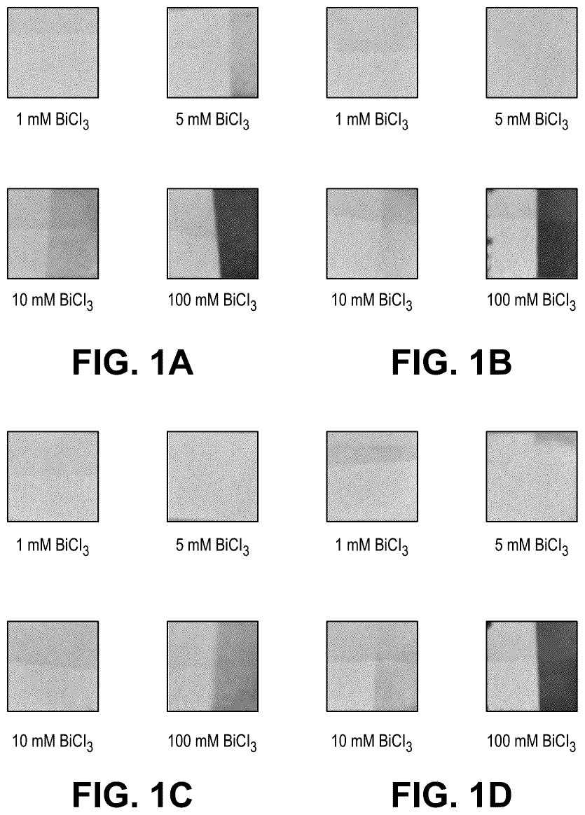

Bismuth oxychloride (BiOCl) is an exemplary example of a photocatalyst with potential applications in clean energy utilization due to its desirable chemical stability and non-toxicity. However, BiOCl has a wide band gap that makes it to respond only to ultraviolet (UV) light and hence significant research effort has been directed to reduce its band gap to make it respond to visible light. Interestingly, this UV adsorption has the potential to be used for UV sensor applications that has not been explored. Upon exposure to UV radiation, BiOCl goes to an excited energy state. This energy could be transferred to other dye molecules to induce a color change. In examples of the present disclosure, this excited energy state is associated with a color change from white color to black. This color change is quantifiable especially when BiOCl is deposited on a proper substrate such as a Whatman filter paper. Other absorbent media, such as, but not limited to natural or synthetic fabrics, polysulfone and polyethersulfone substrates, teflons, silicon wafers, or combinations thereof, may be used. For example, four different concentrations of BiOCl solution in ethanol, 1 mM, 5 mM, 10 mM and 100 mM, were prepared and soaked Whatman filter papers in these solutions. These BiOCl deposited filter papers were exposed to different UV radiation sources (254, 302 and 364 nm and sun light) which induced color changes with varying intensity as shown in FIGS. 1A-1D. FIGS. 1A-1D are a series of photographs depicting soaked and dried filter paper squares in 1 mM, 5 mM, 10 mM, and 100 mM BiCl₃ dissolved in ethanol and exposed to 254 nm UV, 302 nm UV, 365 nm UV, and sunlight, respectively, for one hour, in accordance with the present disclosure. It should be noted that increased concentration of BiOCl in ethanol results in a more apparent color change upon exposure to all evaluated wavelengths of UV exposure. Illustrative examples of the present disclosure may include a metal oxyhalide concentration from about 5 mM to about 1M, from about 10 mM to about 500 mM, or from about 50 mM to about 200 mM.

In exemplary examples, other metal oxyhalides that reach an excited state on exposure to x-ray or ultraviolet radiation may be used in practicing the detection methods or devices described herein. Illustrative examples of metal oxyhalides include, but are not limited to bismuth oxyhalides, or bismuth oxychloride. Other examples can include oxyhalides of metals such as lead, tin, antimony, lanthanum, scandium, titanium, copper, other lanthanide-based oxyhalides, or combinations thereof. Other examples can include metal oxyhalides formed with fluorine, chlorine, bromine, iodine, or combinations thereof. In certain examples, the metal oxyhalide can be in solution or dispersion form, or alternatively in solid particulate form. In particulate form, the metal oxyhalide may be present in the form of particles in a range from about 1 nm to about 5000 nm, with varying particle shapes such as nanoneedles, nanospheres, hexagons, decahedra, nanoplates, and nanosheets, cylinders, or combinations thereof. In other examples of the present disclosure, the metal oxyhalide can be combined in solution with a dye, for example, a redox reactive dye or a fluorescent dye. Illustrative examples of suitable dyes include Rhodamine B, fluorescein, 6-carboxy fluorescein, 5-carboxy fluorescein, coumarins, combinations thereof, and the like. When in solution form, illustrative examples of solvents to dissolve or disperse metal oxyhalides or dyes, or other components for devices and detection methods of the present disclosure can include Lewis base solvents, such as water, alcohols such as methanol, ethanol, propanol, and the like, and higher molecular weight solvents such as ethylene glycol.

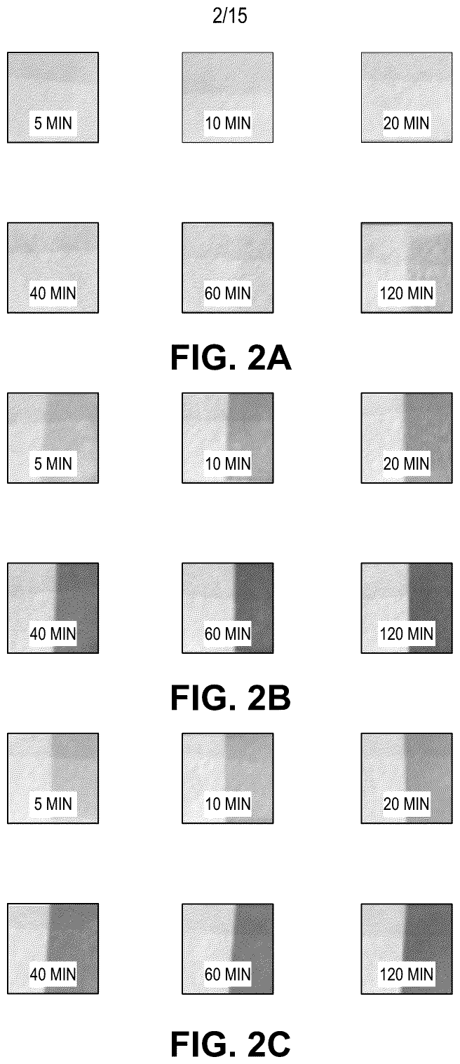

FIGS. 2A-2C are a series of photographs depicting soaked and dried filter paper squares in 1 mM 6-carboxy fluorescein (6-CF) and 100 mM BiCl₃ in ethanol exposed to 365 nm UV, 302 nm UV, and 254 nm UV, respectively, at various time lengths, in accordance with the present disclosure. The addition of a fluorescent dye can improve ability to distinguish the color change initiated by UV exposure more readily. To this purpose, 6-carboxy fluorescein (6-CF), a non-hazardous dye, was utilized. For the experimental measurements, small filter paper squares were soaked in an ethanol solution containing 1 mM 6-CF and 100 mM bismuth trichloride (BiCl₃) followed by drying at room temperature. These squares were then exposed to 254 nm, 302 nm, and 365 nm UV light for various time durations from 5 minutes to 120 minutes, as noted in FIGS. 2A-2C. Each wavelength produced a different range of darkening which will allow for the creation of a calibration curve. With appropriate use of UV filters such a device based on the principles described herein can be used to measure the exposure of individual UV ray (UV-A, UV-B and UV-C) exposure. These calibration curves will provide for the determination of UV exposure of the exposed sample and the wavelength of the UV exposure with the combined use of such a device with any simple color scanning app.

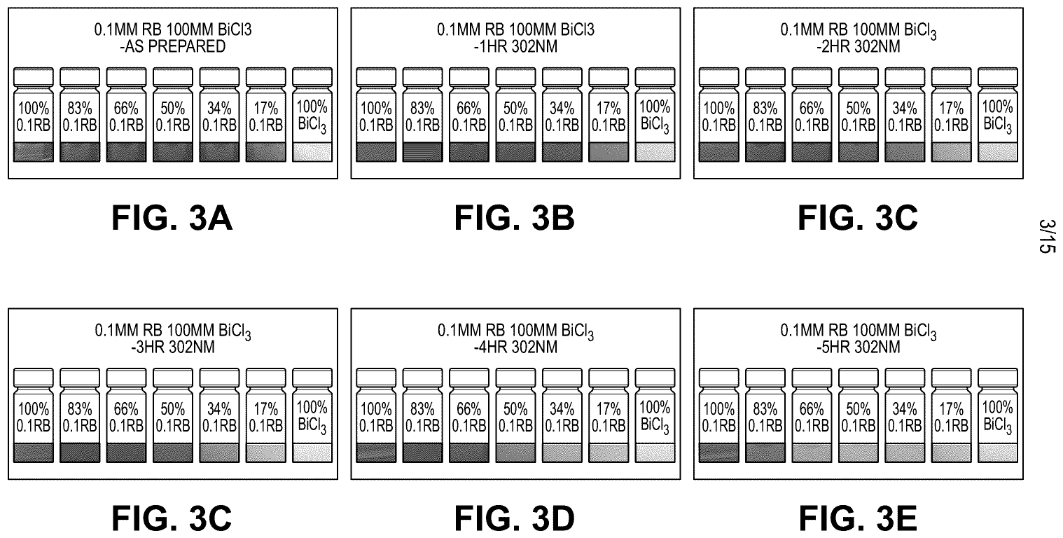

FIGS. 3A-3F are a series of photographs depicting various percentages of 0.1 mM Rhodamine B (RB) and 100 mM BiCl₃ in ethanol as prepared, and exposed to 302 nm UV light for 1 hour, 2 hours, 3 hours, 4 hours, and 5 hours, respectively, in accordance with the present disclosure. The BiOCl was prepared by in-situ hydrolysis by dissolving BiCl₃ in ethanol where BiCl₃ reacts readily with ethanol and ambient water to form BiOCl. The in situ synthesis of the BiOCl has been independently confirmed using X-ray diffraction phase analysis. When BiOCl is irradiated with UV radiation, BiOCl enters a stable, excited energy state. Electrons move from their ground state into a higher energy band gap. Without wishing to be bound by any particular theory, this excitation is believed to cause the color darkening in the filter paper samples as shown in FIGS. 2A-2C. The excited state of BiOCl remains stable with the evaluated filter paper samples described herein remaining dark for more than a week. This excited state energy can also be used in conjunction with redox reactive dyes such as Rhodamine B (RB) to create a permanent color change. To further explore this BiOCl interaction with RB, seven different solutions containing various compositions of 0.1 mM Rhodamine B and 100 mM BiCl₃ in ethanol were prepared. The solutions were labeled on the vial based on the percentage of Rhodamine B included in solution, as follows: 100%, 83%, 66%, 50%, 34%, 17% and 0% (100% BiOCl).

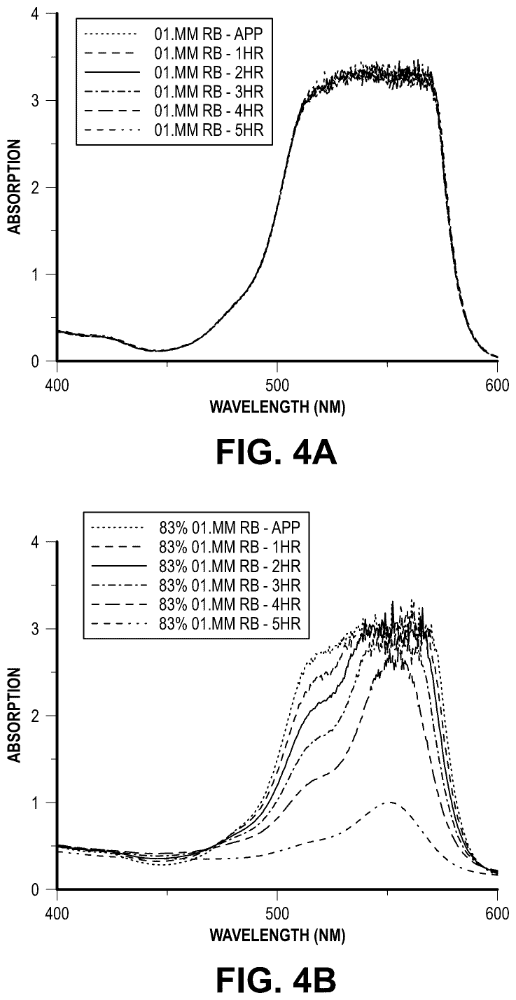

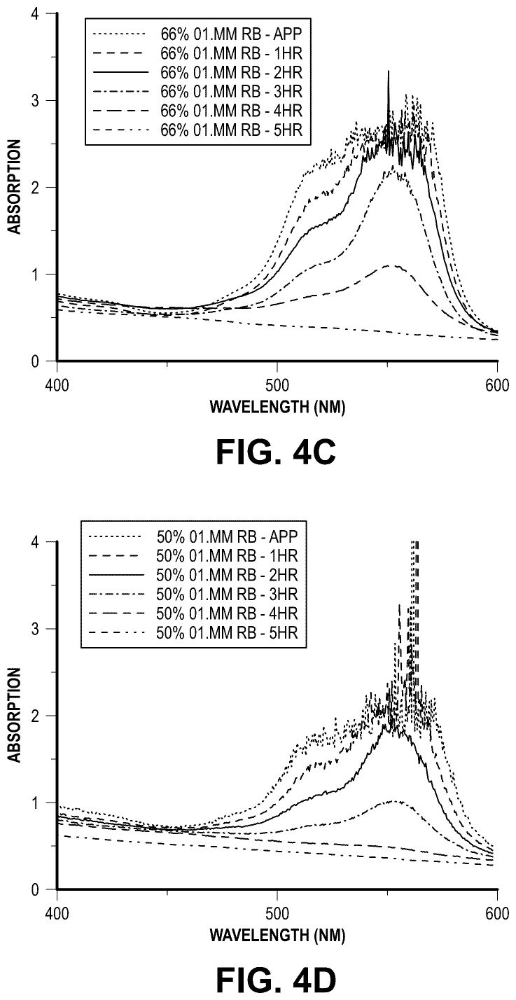

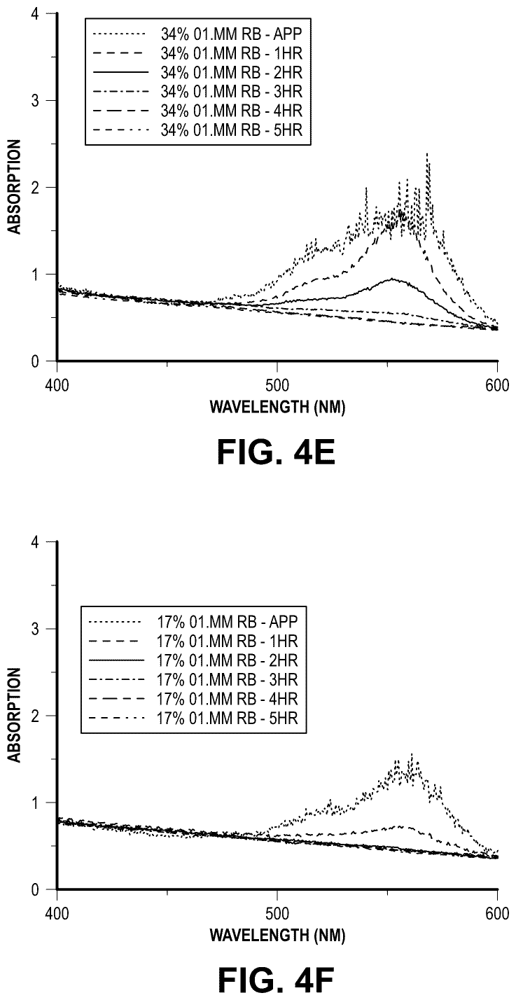

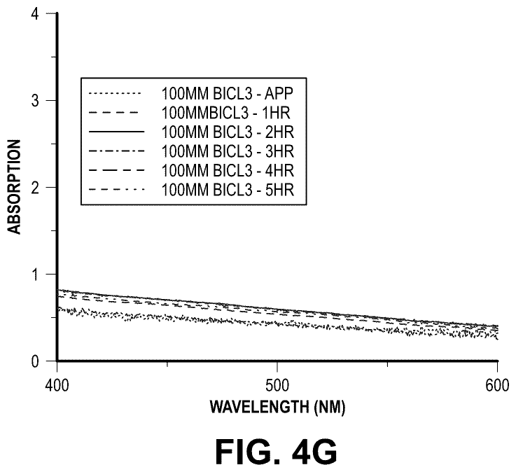

FIGS. 4A-4G are plots depicting UV-Vis absorption data for various percentages of 0.1 mM Rhodamine B (RB) and 100 mM BiCl₃ in ethanol exposed to 302 nm UV light, for compositions including 100% RB, 83% RB, 66% RB, 50% RB, 34% RB, 17% RB, and 100% BiCl₃, respectively, in accordance with the present disclosure. All seven solutions as described in regard to FIGS. 3A-3F were exposed to 302 nm UV light for 5 hours with UV-Vis absorption data acquired once each hour. RB has a characteristic absorption peak around 550-600 nm in the UV-Vis as shown in FIG. 4A that did not change after exposure to UV radiation over a wide range of time from 1 to 5 hours, which serves as an indication of the inertness of RB when exposed to UV radiation. However, solutions containing both RB and BiOCl, as shown in FIG. 4B—83% RB, FIG. 4C—66% RB, FIG. 4D—50% RB, FIG. 4E—34% RB, FIG. 4F—17% RB, and FIG. 4G—100% BiCl3, all showed noticeable loss of color of the RB dye after each hour of exposure. This was caused by the transfer of energy from the excited state of BiOCl to the Rhodamine B, causing decomposition of the Rhodamine B. As the experiment progressed, the UV-Vis absorption peaks associated with Rhodamine B decreases until only the BiOCl spectrum remains. Solutions containing lower concentrations of Rhodamine B degraded the fastest while solutions with higher percentages of Rhodamine B degraded at a slower rate. While the 100% Rhodamine B remained unchanged for the total 5 hours of exposure, all solutions containing BiOCl and RB lost color, meaning that Rhodamine B itself is stable under 302 nm UV light and the color change can be attributable to the presence of BiOCl in each solution.

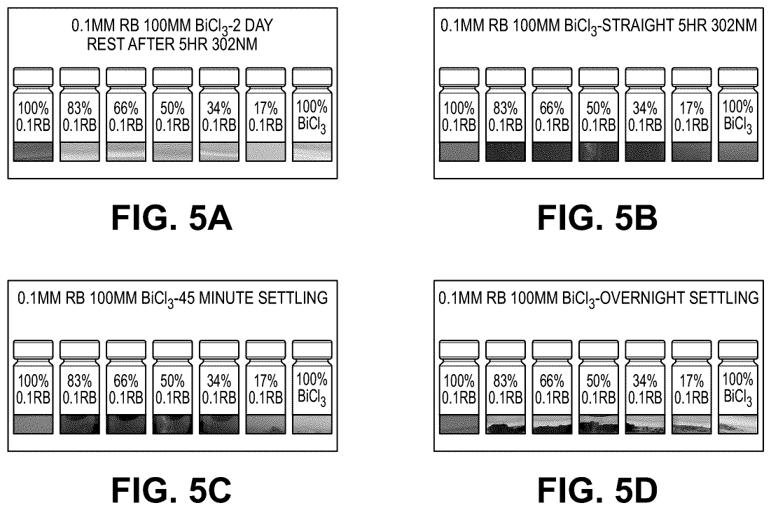

FIGS. 5A-5D are photographs depicting various percentages of 0.1 mM Rhodamine B (RB) and 100 mM BiCl₃ in ethanol exposed to 302 nm UV light for 5 hours, continuously, with a 2-day rest after the initial 5-hour exposure to 302 nm UV light, immediately after the 5-hour exposure, 45 minutes after the 5-hour exposure, and after overnight settling, respectively, in accordance with the present disclosure. The UV exposure of the solutions described in regard to FIGS. 3A-3F and FIGS. 4A-4G, was continued further to understand and observe any after-effects of UV exposure. The solutions were left undisturbed to settle for two days after which it could be observed that all color in the solutions, as expected, was gone. Further exposure to UV radiation for 5 hours resulted in the appearance of a black color in solutions containing BiOCl, which can be indicative of the ability of BiOCl to continually absorb UV light in order to reach the excited state. These black solutions were then left to settle, and over time, a black precipitate was observed. X-ray diffraction analysis of the black precipitate showed that it was a 50/50 mixture of bismuth metal and BiOCl indicating that some of the BiOCl is dissociated to Bi metal upon continued exposure to UV radiation. The 100% Rhodamine B remains unchanged through the described measurements and experiments as shown in FIGS. 5A-5D. This therefore demonstrates a technology for monitoring the UV exposure for a variety of applications, which will be further described herein. These results conclusively demonstrate BiOCl to be a promising material for colorimetric UV sensor applications with its chemical safety as compared to alternatives and wavelength sensitivity.

Examples of the present disclosure include compositions including bismuth chloride, which reacts with air or solvents to form BiOCl and will change colors when exposed to UV radiation. Examples may further include a dye, which can enhance color changes with or without participating in the reaction. In such cases where the dye does not participate in the reaction, no degradation of the dye occurs. Rhodamine B may be chemically degraded in a reaction and fades away as a result of the reaction, resulting in a conversion to bismuth metal and dye reaction products.

Additional examples of the present disclosure include the introduction of BiOCl onto paper substrates, and a mechanism where the sensitivity is enhanced with the use of dyes. BiOCl may be deposited onto paper or other absorbent substrates or media from a solution. Alternate oxyhalides of bismuth or of lead, tin, antimony, or lanthanide series metals may be useful as well in similar radiation detectors. More intense colorimetric changes may occur at higher concentrations, due to higher light absorbance, when absorbed onto papers from a liquid form, rather than in powder form. Prussian blue may be used as another non-interactive dye, as it provides contrast. Alternate examples using fluorescent dyes may exhibit greater contrast as compared to Prussian Blue.

Applications of radiation detectors of the present disclosure can relate to wearable personal dosimetry for medical applications, for example dermatology, as exposure to UV-B can increase sensitivity to developing skin cancer. Additional applications may include measuring the efficiency of sunscreens. For example, a top layer of sunscreen, also referred to as a photoprotective topical lotion, may be applied over a polymer film covering the colorimetric detector to measure the effectiveness of the sunscreen. Certain examples of a radiation detector as described herein, may include a radiation filter for comparative purposes or for filtering radiation that improves the performance of the radiation detector. Such measurements can be conducted over time to determine an expected life or effectiveness time frame of a sunscreen composition. Other applications may include a formation and fabrication of an adherable or fixable UV patch to measure adequacy of a food industry package when food is sterilized, and has been exposed to the sterilization process, which could indicate if the food is safe to consume, or to the utilization of X-ray or gamma rays in food industry, or medical therapies such as the treatment for psoriasis while measuring the skin dosage of radiation therapy.

The use of BiOCl as described herein can provide a photo-sensitive component for UV sensing application can be accompanied by use of a dye for enhancing the contrast between the exposed and unexposed regions. Among several dye molecules studied, 6-CF can be suited from the perspective of providing a better contrast. Also, 6-CF is non-hazardous, hence applicable for the use of this sensor in conditions closer to real world scenarios. Two different approaches were used, (i) testing of the efficiency of commercially available sunscreens in protecting the skin for prolonged periods using our solid-state UV sensor, and (ii) quantifying the exposure of sunlight using optical density measurements. Results obtained with a commercially available sunscreen followed by optical density measurements obtained using ImageJ are described herein.

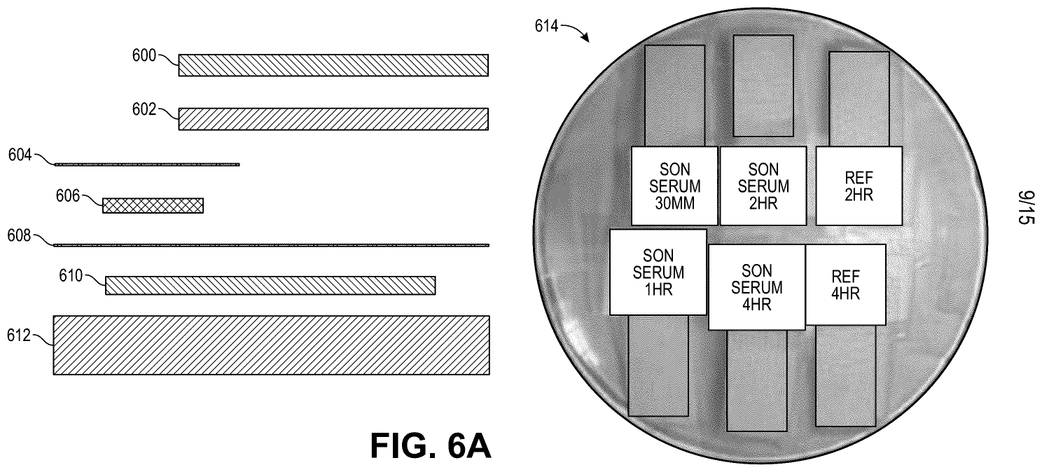

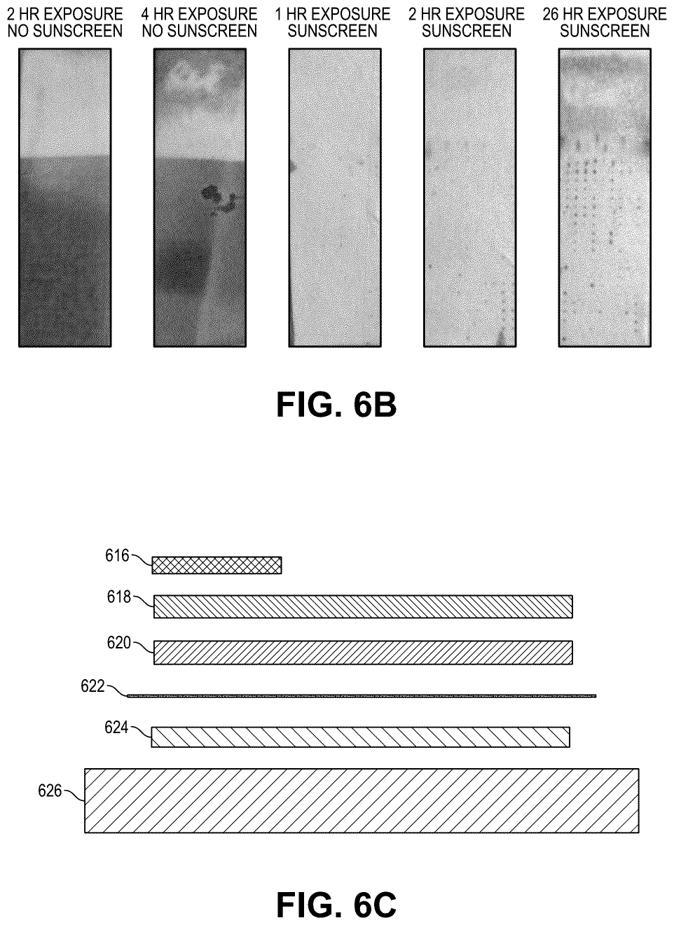

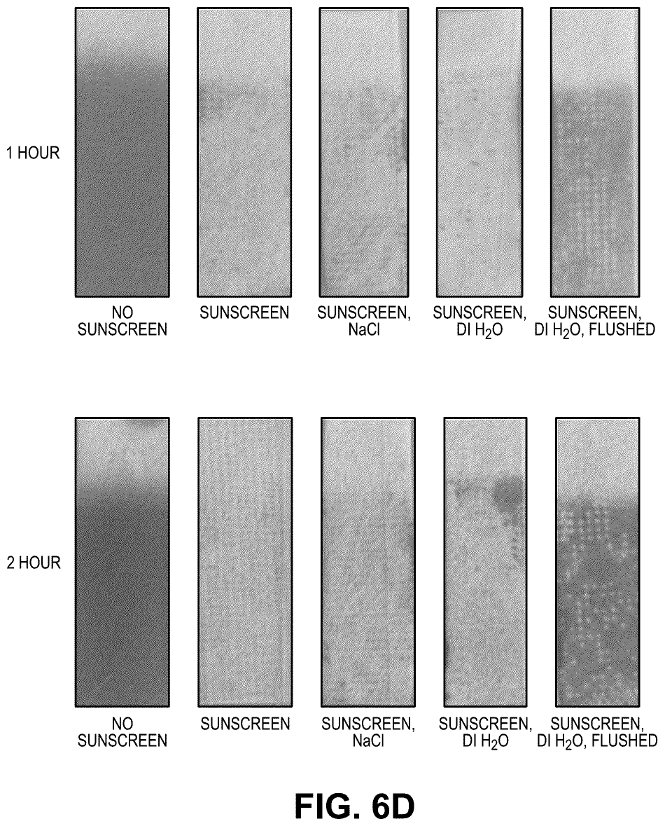

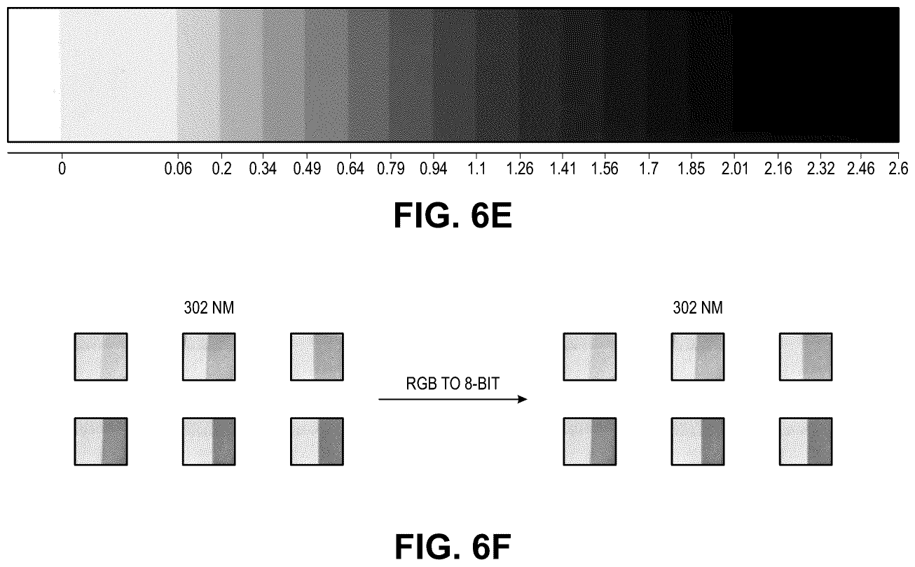

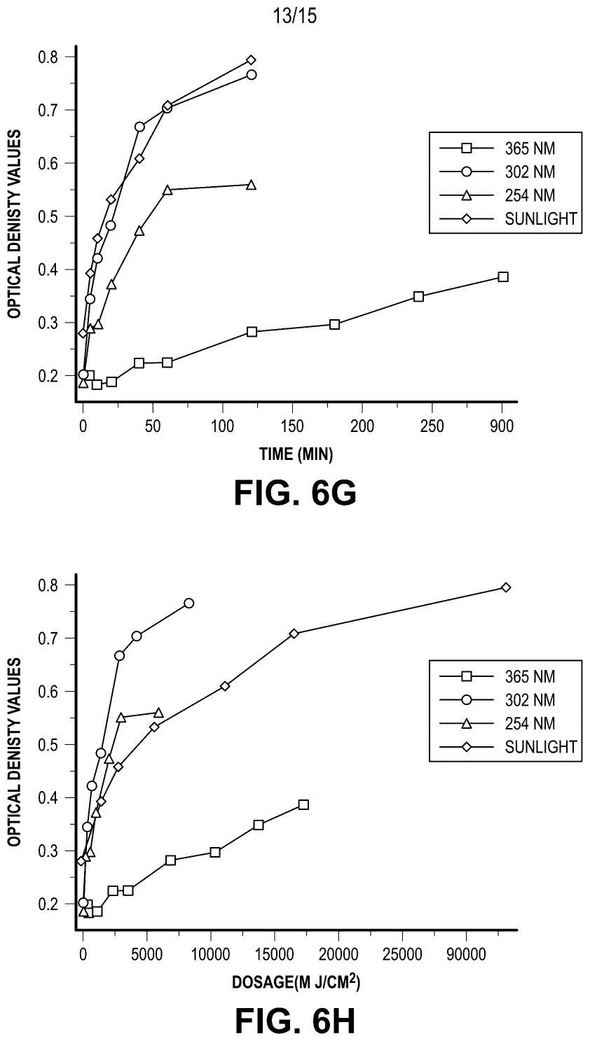

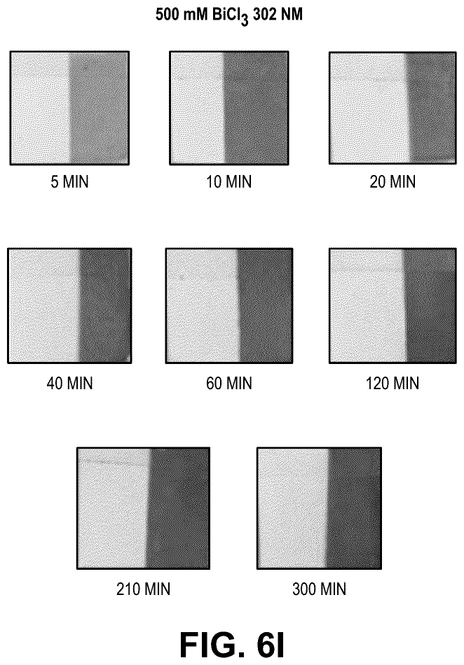

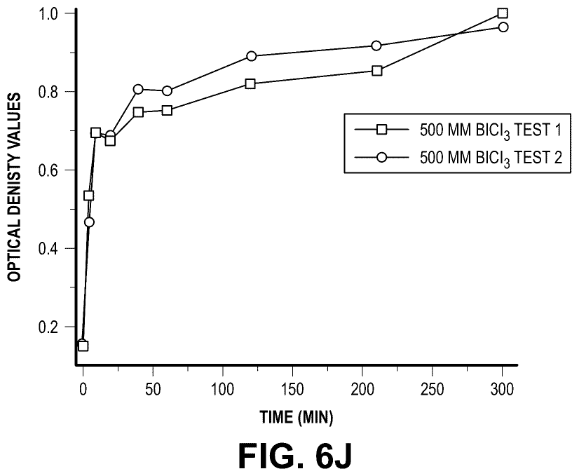

FIG. 6A is a schematic and picture of an experimental setup of a 302 nm UV light SPF 30 sunscreen test, in accordance with the present disclosure. Sunscreen 600 efficiency measurement tests were performed using the 50% 1 mM 6-CF and 100 mM BiCl₃ solid-state sensor and the sunscreen efficiency was tested by exposing them to 302 nm UV light as well as sunlight. Filter paper strips with a size of 1 cm by 4 cm, were soaked in the sensor solution and then dried at room temperature. The resulting UV sensor 610 was placed on top of a glass substrate 612 with Scotch Tape 608 covering the sensor. A UV blocker 606 was placed over a small area of the UV sensor 610 to prevent UV exposure while a layer of 3M™ Transpore™ Tape 602 was applied to the exposed sensor 610 area. Finally, 10 mg of Equate™ Sport Broad Spectrum SPF 30 Lotion (Sunscreen 600) was applied on top of the 3M™ Transpore™ Tape 602. 3M™ Transpore™ Tape was used as an in vitro skin substrate, as recommended by the FDA. The 10 mg of sunscreen 600 applied on top of the 3M Transpore™ Tape 602 was roughly ten times the FDA recommended value 0.75 mg/cm2 of sunscreen in order to ensure complete covering of the UV sensor surface. Equate™ Sport Broad Spectrum SPF 30 Lotion sunscreen was used for both tests as described herein. A schematic of the experimental setup and a photographic image of the experimental setup for the 302 nm UV test is shown in FIG. 6A. Also shown in FIG. 6A is a photographic image 614 of the test sample setup. Two stacked filter paper squares were used as a UV blocker 606 for this test. The glass substrate 612 used was an inverted watch glass to provide a non-uniform distribution of light to the UV sensors 610. This preparation setup was exposed to 302 nm UV radiation for various time durations from an hour to about 26 hours.

FIG. 6B is a photograph depicting results of a 50% 1 mM 6-CF and 100 mM BiCl3 UV sensor SPF 30 sunscreen test with 302 nm UV light, with 2 hour and 4-hour exposure with no sunscreen, 1 hour, 2 hour, and 26 hour exposure with sunscreen, respectively, in accordance with the present disclosure. The results of the 302 nm UV light sunscreen test shown in FIG. 6A are shown in FIG. 6B. As noted in FIG. 6B, the reference sensors with no sunscreen applied were exposed to 2 and 4 hours of 302 nm UV light, respectively. It should be noted that the reference samples did have a layer of 3M™ Transpore™ Tape applied. The next three sensors shown in FIG. 6B include UV sensors with SPF 30 sunscreen applied. Their 302 nm UV exposure was 1 hour, 2 hours, and 26 hours, respectively. As illustrated in FIG. 6B, the two reference samples (2 hr exposure No Sunscreen, and 4 hr exposure, No Sunscreen) turned to a dark brown color upon exposure to UV radiation with no noticeable difference between the 2 and 4-hour exposure times. This observation agrees with experimental results obtained for solid-state UV sensors fabricated with 6-CF and BiCl₃ observed previously. However, the 1-hour, 2-hour, and 26-hour sensors covered in sunscreen showed no discernible color change on heavily applied areas. Also, the 3M™ Transpore™ Tape showed dark spots in the convex regions of the 3M™ Transpore™ Tape that could be possible due to the edges of the mesh-like 3M™ Transpore™ Tape 3M™ Transpore™ Tape receiving or retaining lower sunscreen application as compared to neighboring regions. The dark spots in the 26-hour sunscreen sensor shows considerably darker spots compared to the other two sensors that had sunscreen applied. This could be due to the convex region of 3M™ Transpore™ Tape retaining less sunscreen than the concave regions of 3M™ Transpore™ Tape. The samples denoted 4 hr exposure, No Sunscreen. and 26 hr exposure Sunscreen show a larger amount of darkening in the area that was intended to be covered and unexposed. This may be attributed to the inverted watch glass scattering the UV light and the poor UV blocking of two filter paper squares. While this result made it difficult to distinguish the unexposed area from the exposed area, it did not affect the results of sunscreen test.

FIG. 6C is a schematic of a sunlight and SPF 30 sunscreen test, in accordance with the present disclosure. Another sunscreen 618 test was performed on the same 50% 1 mM 6-CF and 100 mM BiCl₃ solid-state sensor under sunlight. FIG. 6C shows the schematic for the sunlight sunscreen test. A few alterations were made as compared to the 302 nm UV light sunscreen schematic illustrated in FIG. 6A. First, 3M™ Transpore™ Tape 620 was applied over the entire UV sensor 624 and Scotch™ Tape 622 layers. Second, the sunscreen 618 was applied over the entire UV sensor 624, even the UV blocked section 616. Third, the previous filter paper UV blocker was replaced with a metal square as the UV blocker 616. Finally, an inverted glass substrate 612 was replaced with a glass slide 626. These changes to the experimental setup were expected to help eliminate the backscattered UV exposure on the unexposed area as well as limit the UV reflection seen in the 302 nm UV light sunscreen test as described in regard to FIG. 6A.

FIG. 6D is a set of photographs depicting a 50% 1 mM 6-CF and 100 mM BiCl3 UV sensor SPF 30 sunscreen test with sunlight, in accordance with the present disclosure. For the sunlight sunscreen test described in regard to FIG. 6C, five different sunscreen environments were tested, (i) a conventional sensor with no sunscreen applied (No Sunscreen), (ii) a normal application of Equate™ Sport Broad Spectrum SPF 30 Lotion on the sensor (Sunscreen), (iii) stationary addition of 44.8 mM NaCl in DI water to the sunscreen coated sensor (Sunscreen, NaCl), (iv) stationary addition of DI water to the sunscreen coated sensor (Sunscreen, DI H₂O), and (v) 2 minute flush of DI water to the sunscreen coated sensor (Sunscreen, DI H₂O, flushed). The 44.8 mM NaCl solution was made to mimic the sodium content in human sweat with an average sodium ion concentration taken from standard available measured values. The stationary addition of DI water was intended to simulate the effect of stagnant water on sunscreen and the 2 minute flush of DI water was meant to simulate the effect of dynamic water on sunscreen. The photographic images in FIG. 6D illustrates the results of the 1-hour sunlight exposure on these sensors (top row) and the results after 2-hour sunlight exposure on these sensors (bottom row). The patches shown at the leftmost of FIG. 6D represent the reference sensors where no sunscreen was applied to the sensor. The 2-hour sunlight exposure produced a darker shade of brown as compared to the 1-hour sunlight exposure. Both time exposures produced a uniform color change in the exposed area. The sensors coated with sunscreen and exposed to 1-hour and 2-hours respectively, exhibits a slight uniform color change as observed in both sensors (Sunscreen), however, the 2-hour sunlight exposure appears to be slightly darker than the 1-hour exposure. Unlike the 302 nm UV light test as previously described herein, no dark spots from the 3M™ Transpore™ Tape are present on these sunlight exposed sensors. The sensors denoted as (Sunscreen, NaCl) show the impact of a stationary sweat solution applied on top of the sunscreen and exposed to sunlight for 1- and 2-hour time periods. The sweat simulation solution appears to have stripped at least a portion of the sunscreen, allowing for more sunlight to reach the sensor. Dark spots from the 3M™ Transpore™ Tape can be observed, as well as a light uniform darkening of the sensors. The sensors denoted as (Sunscreen, DI H₂O) show the results obtained for sensors with stationary DI water added to the sunscreen coat and exposed to 1- and 2-hour time periods of sunlight. The 1-hour exposure to sunlight produced a lighter uniform color change than the 1-hour sunlight sweat solution. The 2-hour exposure produced the same uniform color change as the 2-hour sweat solution, as well as a noticeable dark spot where the water completely dissolved the sunscreen. The sensors denoted as (Sunscreen, DI H₂O, flushed) show the impact of a 2-minute DI water flush on the sunscreen coated sensor as well as 1 and 2 hours of sunlight exposure. The 1-hour exposure of the sensor produced the second darkest color change as compared to the reference, (No Sunscreen, 2-hour), where no sunscreen was applied on the sensor. The sensor had light spots due to the 3M™ Transpore™ Tape convex regions elevating the sunscreen above the flowing water. The 2-hour sunlight exposure had the same light spots seen in the 1-hour sensor. The color change was slightly lighter than the reference. From this test, it can be determined that the 50% 1 mM and 100 mM BiCl₃ filter paper sensor can be used in conjunction with sunscreen application to measure UV exposure.

FIG. 6E depicts a Kodak No. 3 Calibrated Step Tablet scanned with an Epson Expression 1680 Professional Scanner, denoting optical density values are listed below each step, in accordance with the present disclosure. Optical density measurements can be conducted using solid-state Sensors. Colorimetric UV sensors offer a complementary, inexpensive method for monitoring UV exposure that can be easily scaled up to be used in in a wide variety of applications. For example, utilizing a phone camera, a user can scan the color of the sensor and using a corresponding application (app), can easily measure an exposure dosage. The app will determine the optical density of the sensor and relate the measured optical density value to exposure time and dosage of UV radiation when calibrated against a UV sensor. Optical density can be used to measure the amount of color change in any sample and since the darkening in the solid-state UV sensor of the present disclosure is directly proportional to the exposure to the UV radiation, it can used to monitor the UV dosage. A preliminary relationship between optical density and exposure time can be determined for the colorimetric sensors using the 50% 1 mM 6-CF and 100 mM BiCl₃ solid-state sensor. A simple and readily available software, ImageJ, developed by the National Institutes of Health, was used for calculating the optical density values for our sensors exposed to UV radiation. However, the ImageJ software only measures grayscale values so, a calibration for grayscale values to optical density values was created, as shown in FIG. 6E. The optical density value for every step of the Kodak No. 3 Step Tablet were known, allowing for a straightforward calibration to the UV sensor.

FIG. 6F depicts an 8-bit gray scale conversion of 302 nm solid-state sensor image, in accordance with the present disclosure. After the calibration to the optical density as described in regard to FIG. 6E, the solid-state sensor picture were converted to 8-bit grayscale image using ImageJ. FIG. 6F shows an example of the 8-bit grayscale conversion. This conversion was done in an attempt to mitigate the effects of a smart phone, in this example an iPhone, automatic color correction.

FIGS. 6G and 6H are plots of optical density values of 50% 1 mM 6-CF and 100 mM BiCl3 solid-state sensors when exposed to 365 nm light, 302 nm light, 254 nm light, and sunlight as a function of time and dosage, respectively, in accordance with the present disclosure. Using the calibration derived from the steps described in regard to FIGS. 6E and 6F, the optical density values were obtained for the 50% 1 mM 6-CF and 100 mM BiCl₃ solid state sensor exposed to 365 nm light, 302 nm light, 254 nm light, and sunlight. FIG. 6G compares the optical density values of four different UV exposures with respect to exposure time. The 365 nm UV light (squares) showed the slowest optical density increase over the 300-minute time frame ending with a value of 0.383. This 300-minute optical density value is a similar value seen in the 5-minute value for the 302 nm light, 254 nm light, and sunlight measurements. The exposure time and optical density appear to have a linear relationship. The 302 nm UV light (circles) as well as the sunlight (diamonds) had the fastest optical density increase over a 120-minute period ending with values of 0.766 and 0.795 respectively. Similarly, the 254 UV light (triangle) s had a slightly slower optical density increase and a sharper plateau between the 60-minute and 120-minute optical density values. The 302 nm UV radiation, 254 nm UV radiation, and sunlight all appear to have a logarithmic relationship between exposure time and optical density because of the tapering seen between the 40-minute, 60-minute and 120-minute optical density values, however longer exposure times are needed to determine the actual trend. FIG. 6H plots the optical density values as a function of dosage. The intensity of the UVLMS-38 EL Series 3UV Lamp at 365 nm, 302 nm, and 254 nm were determined to be 0.96 mW/cm2, 1.16 mW/cm2, and 0.82 mW/cm2 respectfully compared to the intensity of sunlight which is approximately 4.61 mW/cm2. The 365 nm sensors were exposed to roughly twice the UV dosage but produced the lightest color change. This is likely due to the 350 nm to 375 nm UV absorption edge associated with BiOCl which resulted in less excitation of BiOCl. The 302 nm sensors produced the second darkest color change after sunlight with about 10 times less exposure. The 254 nm sensors produced the third darkest color change, which could be caused by the low intensity of the 254 nm UV lamp or an upper UV absorption edge that has not been fully determined. Finally, the sunlight sensors produced the darkest color change over the largest dose. The trend of these data points is a between the 365 nm and 302 nm sensors. This most likely corresponds to the 90%-95% UVA and 5%-10% UVB2 present in sunlight as well as approximately 10 times larger intensity of the sunlight exposure compared to 254 nm, 302 nm, and 365 nm.

Table 1 lists the optical density values with respect to exposure time for all four UV exposures. It should be noted that the solid-state sensors exposed to 365 nm UV radiation were purposely exposed for 5 hours due to the slight color change induced by this UV wavelength. The solid-state sensors exposed to 254 nm, 302 nm, and sunlight UV radiation induced a significant color change after 2 hours therefore the sensors were not exposed to any additional UV radiation.

TABLE 1
Optical density values of 50% 1 mM 6-CF and 100 mM BiCl₃ solid-state
UV sensor Exposed to 365 nm, 302 nm, 254 nm, and sunlight.

| Time (min) | 365 nm |
|---|---|
| 0 | 0.195 |
| 5 | 0.198 |
| 10 | 0.182 |
| 20 | 0.188 |
| 40 | 0.221 |
| 60 | 0.221 |
| 120 | 0.280 |
| 180 | 0.293 |
| 240 | 0.346 |
| 300 | 0.383 |

| Time (min) | 302 nm | 254 nm | Sunlight |
|---|---|---|---|
| 0 | 0.201 | 0.184 | 0.278 |
| 5 | 0.343 | 0.284 | 0.391 |
| 10 | 0.420 | 0.291 | 0.457 |
| 20 | 0.482 | 0.366 | 0.531 |
| 40 | 0.666 | 0.469 | 0.608 |
| 60 | 0.703 | 0.547 | 0.709 |
| 120 | 0.766 | 0.558 | 0.795 |

FIGS. 6I and 6J depict filter paper squares soaked in 500 mM BiCl3 and ethanol exposed to 302 nm UV light for various durations, and a Plot of optical density values with respect to 302 nm exposure time, respectively, in accordance with the present disclosure. Following the 50% 1 mM 6-CF and 100 mM BiCl₃ optical density measurements, a darker color change in the sensor was desired since the previous sensors only achieved a maximum optical density of 0.795. A new solid-state sensor was prepared using 500 mM BiCl₃ dissolved in ethanol without 6-CF. Similar Like past solid-state sensors of the present disclosure, filter paper squares were soaked in the solution for 5 minutes and dried at room temperature. FIG. 6I is a photo of the 500 mM BiCl₃ solid-state sensors after exposure to 302 nm UV light while FIG. 6J is a plot of the optical density values with respect to exposure time for two tests. After 40 minutes, it appears that no further color change occurred in the sensors, however, looking at the optical density plot an optical density increase can be seen up to the maximum UV exposure time of 300 minutes. A trend can be observed in the optical density plots where the 10-minute example has a slightly higher optical density value than the 20-minute value. The same is seen for the 40-minute and 60-minute optical density values. After 60 minutes, a slight increase in the optical density values can be observed. It is unclear what is causing this dip in optical density, but it could be due to the placement of the sensor under the UV lamp or with the preparation of the sensor. Overall, as shown in FIGS. 6I and 6Ja higher optical density value was achieved for the 500 mM BiCl₃ solid-state sensor.

In the method and devices described in the present disclosure include providing a colorimetric radiation detector, where the colorimetric radiation detector includes a metal oxyhalide that reaches an excited state on exposure to x-ray or ultraviolet radiation and a dye that undergoes a permanent color change by reacting with the metal oxyhalide when the metal oxyhalide is exposed to x-ray or ultraviolet radiation, exposing the colorimetric radiation detector to radiation, and detecting a change in color of the colorimetric radiation detector. The color change may be detected visually, or detected visually in combination with one or more scanning or UV/visible detection methods known to a person skilled the art. Examples of the present disclosure further include the detection and corresponding color change in response to exposure to x-rays, gamma rays, alpha and beta particles, or combinations thereof, in addition to ultraviolet radiation. In exemplary examples, the metal oxyhalide includes a bismuth oxychloride, and the dye can include Rhodamine B. Another method for evaluating a photoprotective topical lotion is disclosed, which includes providing a colorimetric radiation detector with a metal oxyhalide that reaches an excited state on exposure to x-ray or ultraviolet radiation, applying a skin-like testing substrate over at least a portion of the colorimetric radiation detector, applying a photoprotective topical lotion onto at least a portion of the skin-like testing substrate, exposing the colorimetric radiation detector to radiation, and detecting a change in color of the colorimetric radiation detector. It should be noted that alternate methods or practices in applying a photoprotective lotion may be used, such as application of a photoprotective aerosol propelled spray or liquid composition providing photoprotective properties. In certain examples of evaluating a photoprotective topical lotion, the colorimetric radiation detector further includes a dye that undergoes a permanent color change by reacting with the metal oxyhalide when the metal oxyhalide is exposed to x-ray or ultraviolet radiation. In certain examples, the radiation is exposed to the colorimetric radiation detector in a non-uniform distribution, or alternatively can be in the ultraviolet range. In some examples, evaluating a photoprotective topical lotion includes blocking at least a portion of the colorimetric radiation detector from being exposed to radiation for comparative purposes. The metal oxyhalides and dyes incorporated into the colorimetric radiation detector include examples as previously described herein.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

We claim:

1. A colorimetric radiation detector, comprising:
a metal oxyhalide that reaches an excited state on exposure to x-ray or ultraviolet radiation; and
a dye.

2. The colorimetric radiation detector of claim 1, wherein the metal oxyhalide comprises a bismuth oxyhalide.

3. The colorimetric radiation detector of claim 2, wherein the metal oxyhalide comprises a bismuth oxychloride.

4. The colorimetric radiation detector of claim 1, wherein the dye comprises a redox reactive dye.

5. The colorimetric radiation detector of claim 4, wherein the redox reactive dye comprises Rhodamine B.

6. The colorimetric radiation detector of claim 1, wherein the dye undergoes a permanent color change by reacting with the metal oxyhalide when the metal oxyhalide is exposed to x-ray or ultraviolet radiation.

7. The colorimetric radiation detector of claim 1, wherein the dye comprises a fluorescent dye.

8. The colorimetric radiation detector of claim 7, wherein the fluorescent dye comprises a fluorescein dye.

9. The colorimetric radiation detector of claim 8, wherein the fluorescein dye comprises 6-carboxy fluorescein.

10. The colorimetric radiation detector of claim 8, wherein the fluorescein dye comprises 5-carboxy fluorescein.

11. The colorimetric radiation detector of claim 1, further comprising an absorbent medium onto which the metal oxyhalide and the dye are absorbed.

12. The colorimetric radiation detector of claim 11, wherein the absorbent medium comprises paper.

13. The colorimetric radiation detector of claim 1, further comprising a solvent and wherein:
a metal halide and the dye are dissolved in the solvent; and
the metal oxyhalide is formed by introducing the metal halide into the solvent.

14. The colorimetric radiation detector of claim 13, wherein the solvent comprises a Lewis base solvent.

15. The colorimetric radiation detector of claim 14, wherein the Lewis base solvent comprises water or an alcohol.

16. The colorimetric radiation detector of claim 13, wherein a concentration of the metal oxyhalide is from about 5 mM to about 1M.

17. The colorimetric radiation detector of claim 1, further comprising a radiation filter.

18. The colorimetric radiation detector of claim 17, wherein the radiation filter absorbs radiation within a portion of a range of ultraviolet radiation.

19. A method for detecting radiation, comprising:
providing a colorimetric radiation detector, the colorimetric radiation detector comprising:
a metal oxyhalide that reaches an excited state on exposure to x-ray or ultraviolet radiation; and
a dye that undergoes a permanent color change by reacting with the metal oxyhalide when the metal oxyhalide is exposed to x-ray or ultraviolet radiation;
exposing the colorimetric radiation detector to radiation; and
detecting a change in color of the colorimetric radiation detector.

20. The method for detecting radiation of claim 19, wherein the metal oxyhalide comprises a bismuth oxychloride.

21. The method for detecting radiation of claim 19, wherein the dye comprises Rhodamine B.

22. A method for evaluating a photoprotective topical lotion, comprising:
providing a colorimetric radiation detector comprising a metal oxyhalide that reaches an excited state on exposure to x-ray or ultraviolet radiation;
applying a skin-like testing substrate over at least a portion of the colorimetric radiation detector;
applying a photoprotective topical lotion onto at least a portion of the skin-like testing substrate;
exposing the colorimetric radiation detector to radiation; and
detecting a change in color of the colorimetric radiation detector.

23. The method for evaluating a photoprotective topical lotion of claim 22, wherein the colorimetric radiation detector further comprises a dye that undergoes a permanent color change by reacting with the metal oxyhalide when the metal oxyhalide is exposed to x-ray or ultraviolet radiation.

24. The method for evaluating a photoprotective topical lotion of claim 22, wherein the radiation is exposed to the colorimetric radiation detector in a non-uniform distribution.

25. The method for evaluating a photoprotective topical lotion of claim 22, wherein the radiation exposed to the colorimetric radiation detector is in the ultraviolet range.

26. The method for evaluating a photoprotective topical lotion of claim 22, further comprising blocking at least a portion of the colorimetric radiation detector from being exposed to radiation.

27. The method for evaluating a photoprotective topical lotion of claim 22, wherein the metal oxyhalide comprises a bismuth oxyhalide.

28. The method for evaluating a photoprotective topical lotion of claim 27, wherein the metal oxyhalide comprises a bismuth oxychloride.

29. The method for evaluating a photoprotective topical lotion of claim 23, wherein the dye comprises a fluorescent dye.
